(19) United States
(12) Patent Application Publication
(10) Pub. No.: US 2016/0055775 A1
(43) Pub. Date: Feb. 25, 2016

(54) APPARATUS FOR DISPLAYING INFORMATION

(71) Applicant: SignX Corporation, New Berlin, WI (US)

(72) Inventor: MICHAEL J. LANDWEHR, Brookfield, WI (US)

(73) Assignee: SignX Corporation, New Berlin, WI (US)

(21) Appl. No.: 14/823,932

(22) Filed: Aug. 11, 2015

Related U.S. Application Data
(60) Provisional application No. 62/040,147, filed on Aug. 21, 2014.

(51) Int. Cl. G09F 7/18

(52) U.S. Cl. CPC G09F 7/18; G09F 2007/1843; G09F 2007/1856; G09F 2007/1873

(57) ABSTRACT

An apparatus for presenting a communication/displaying information is disclosed. The apparatus provides an improved configuration in which frame sections are attached to provide a frame for an insert/communication on a removable structure. The insert structure is installed through a slot and seated/retained in the frame. The insert structure may have a portion extending beyond the slot. The insert structure may comprise a flexible sheet, paper, card, rigid sheet, plastic sheet, etc.

### FIELD

The present invention relates to an apparatus for displaying information. The present application claims priority to and incorporates by reference U.S. Application No. 62/040,147 titled “Apparatus for Displaying Information” filed on Aug. 19, 2014.

### BACKGROUND

It is known to provide an apparatus for providing advertisement on a gasoline pump hose. Such an apparatus is disclosed in U.S. Pat. No. 6,233,858 titled “Apparatus for Providing Advertisement on a Gasoline Pump Hose” and commercialized in substantially the same form to provide a generally rectangular frame with a central opening (also generally rectangular) for viewing an insert/structure providing an advertisement/media. The apparatus of U.S. Pat. No. 6,233,858 comprises a frame of two frame halves coupled by a living hinge; the insert is placed into the frame and the frame halves are closed together at the hinge and secured by a hose connector collar which is then connected to the hose of the gasoline pump (e.g. by clamps).

The apparatus of U.S. Pat. No. 6,233,858 (incorporated by reference) can be improved/modified in form to achieve advantages that are not realized in the apparatus and/or its commercial embodiment.

### SUMMARY

The present invention relates to an apparatus for displaying information at a fueling system providing a hose to refuel a vehicle. The apparatus comprises a base configured for attachment to the hose, a frame comprising a first frame section and a second frame section and a mechanism to secure the first frame section to the second frame section to form the frame. The frame is configured to display information on a structure. When the base is attached to the hose the frame with structure comprising information is visible at the fueling system.

The present invention also relates to an apparatus for displaying information at a repowering system providing a tube by which to repower a vehicle. The apparatus comprises a base configured for attachment to the tube, a first frame section providing the base, a second frame section attachable to the first frame member and a frame comprising the first frame section and second frame section configured to display information on a structure. When the base is attached to the base information on the structure at the frame is positioned to be visible at the system.

The present invention also relates to a method of configuring an apparatus for displaying information. The apparatus comprises a base and a frame provided on at least one structure at a fueling system providing a hose configured to refuel a vehicle. The method comprises providing the apparatus with the base attachable to the hose, providing the structure with information at the frame coupled to the base and displaying information on the structure at the frame by attachment of the apparatus to the hose. When the apparatus is attached to the hose at the base information on at least one structure at the frame is visible at the fueling system. The apparatus is configured so that information can be changed at the apparatus without removal of the base from the hose.

### FIGURES

FIG. 1 is a perspective schematic view of a station with an apparatus for displaying information according to an exemplary embodiment.

FIG. 2 is a perspective schematic view of the apparatus for displaying information according to an exemplary embodiment.

FIG. 3 is a top plan schematic view of the apparatus for displaying information according to an exemplary embodiment.

FIG. 4 is an exploded perspective schematic view of the apparatus for displaying information according to an exemplary embodiment.

FIG. 5 is an exploded perspective schematic view of the frame/base of the apparatus for displaying information according to an exemplary embodiment.

FIGS. 6A and 6B are cross-section plan schematic views of the frame of the apparatus for displaying information according to an exemplary embodiment.

FIGS. 7A through 7C are cross-section detail schematic views of the frame of the apparatus for displaying information according to an exemplary embodiment.

FIG. 8A is an exploded perspective schematic view of the apparatus for displaying information according to an exemplary embodiment.

FIG. 8B is a perspective schematic view of the apparatus for displaying information according to an exemplary embodiment.

FIG. 9A is an exploded perspective schematic view of the apparatus for displaying information according to an exemplary embodiment.

FIG. 9B is a perspective schematic view of the apparatus for displaying information according to an exemplary embodiment.

FIG. 10A is a perspective schematic view of an alternative embodiment of the apparatus for displaying information according to an exemplary embodiment.

FIG. 10B is a plan schematic view of an alternative embodiment of the apparatus for displaying information according to an exemplary embodiment.

### DESCRIPTION

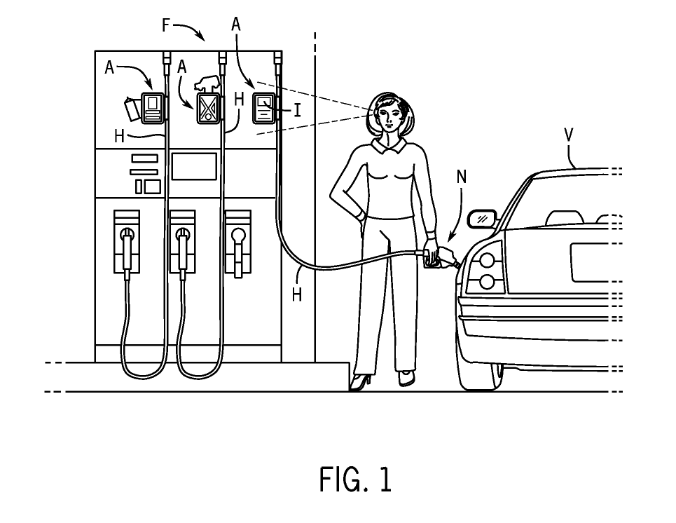

Referring to FIG. 1, a station such as a filling station S with a fueling system F comprising a gasoline pump is shown schematically according to an exemplary embodiment; a customer at a station is shown pumping gasoline/fuel through a hose H with nozzle into a vehicle shown as car V.

As indicated in FIG. 1, an apparatus A for presenting a communication/displaying information such as an advertisement message is attached and/or connected to the hose H at each pump F. As shown schematically in FIG. 1, according to an exemplary embodiment the apparatus A is attached to the hose H at about eye level of the customer and in any event in a position of relative visual prominence to a customer at or operating the pump F. According to other exemplary and alternative embodiments, the gasoline pump can be of any suitable configuration that is presently used or that may be used in the future; the apparatus can be attached or connected at the pump/station by any suitable method or manner (including but not limited to at or on a hose for a pump as indicated or in any other manner).

According to an exemplary embodiment shown schematically in FIG. 1, the gasoline pump F comprises a set of at least one pump with a hose H provided with a generally vertical orientation (a set of three pumps/hoses H is shown in FIG. 1); the hose is of a generally flexible and resilient (e.g. elastomeric) material.

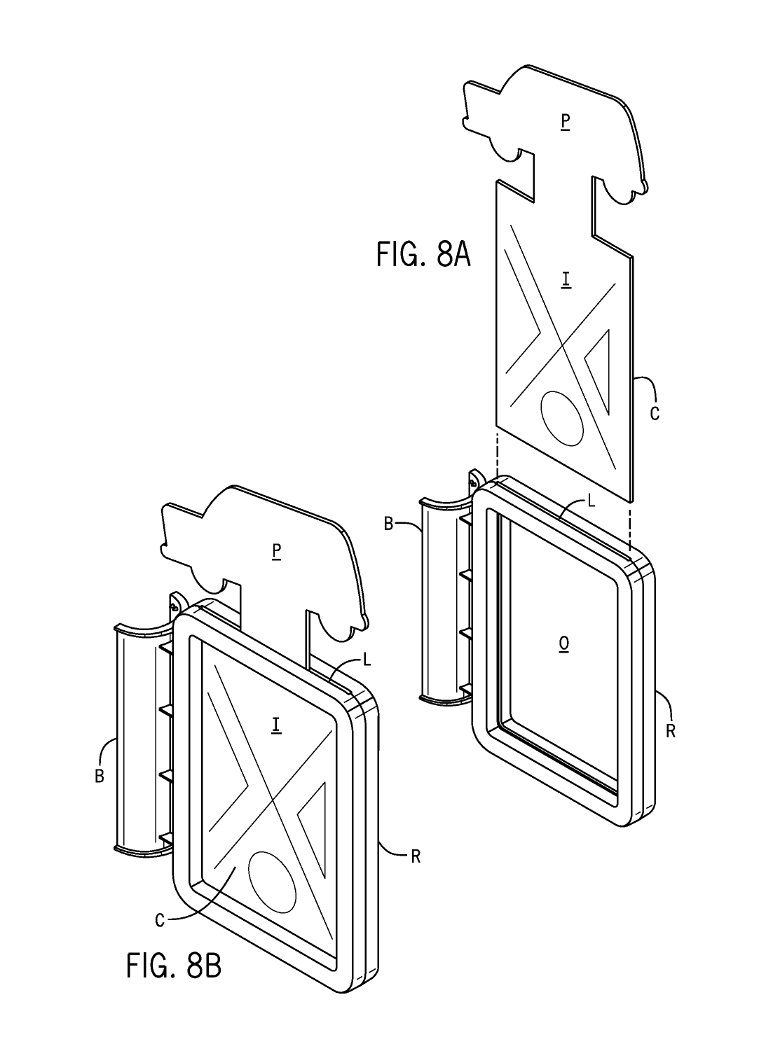

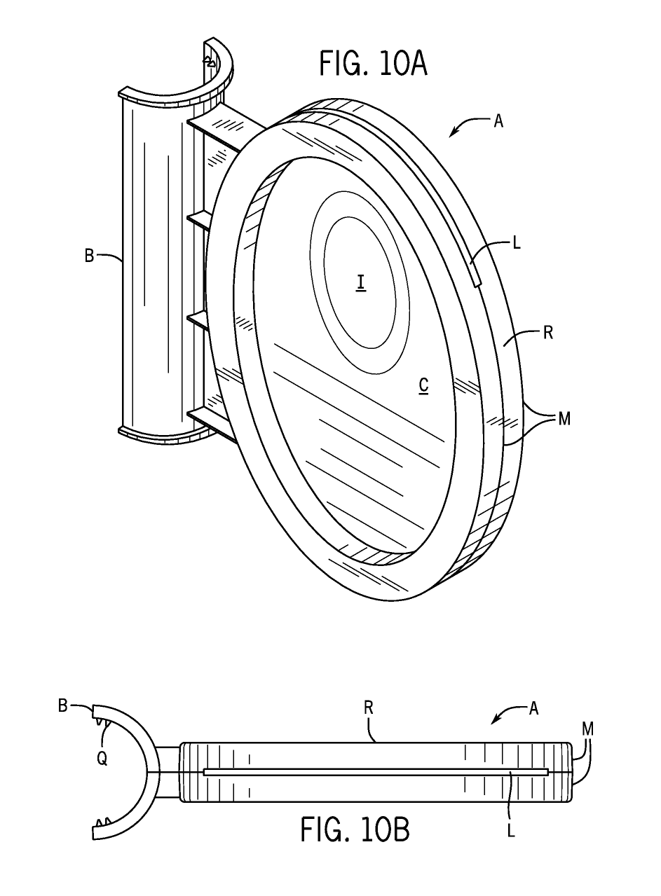

As indicated in FIGS. 1 through 5, the apparatus A comprises a frame F with an opening 0 for display of a communication C; a communication C (e.g. insert, placard, sheet, structure, etc.) is provided in apparatus A. According to an exemplary embodiment each apparatus may present a same/similar communication or a different communication (see FIGS. 1, 8A/B and 9A/B) and/or form/shape (see FIGS. 1 and 10A/B).

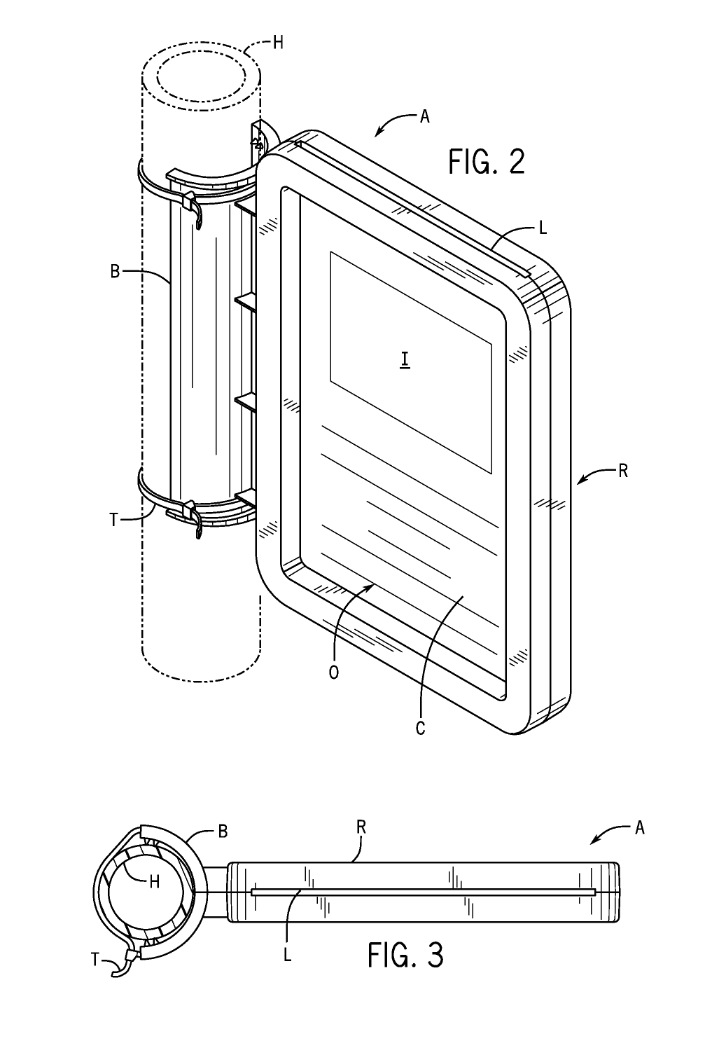

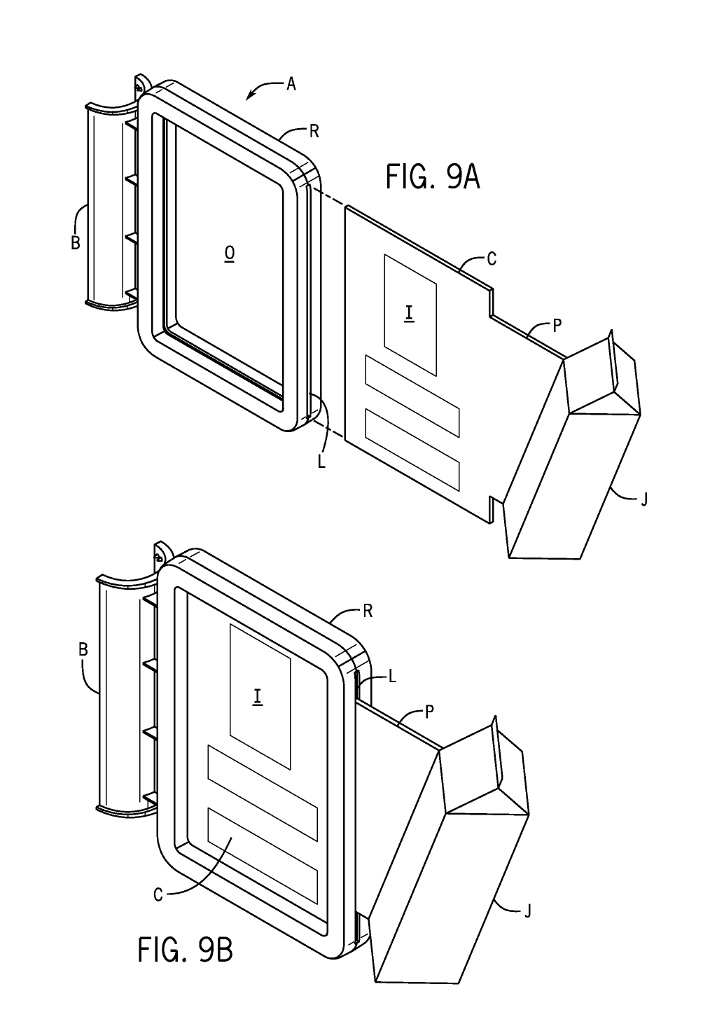

According to an exemplary embodiment as shown in FIGS. 1 through 4, the apparatus A comprises a base B for connection or coupling to a hose H (of the pump F). According to an exemplary embodiment as indicated in FIGS. 2-4, the apparatus A is coupled or affixed to the hose H using a fastener or members shown as ties T (e.g. “zip ties” or the like, which secure the base to the hose). A slot L for insert/communication C (e.g. structure such as a sheet or form/object) is provided at the top (see FIGS. 4 and 8A/B) or side (see FIGS. 9A/B) of the frame F.

According to an exemplary embodiment as shown schematically in FIG. 4, the insert/communication C can be inserted through a slot L in the frame F of the apparatus A. See also FIGS. 8A/B and 9A/B. As shown schematically in FIGS. 1 and 2, the insert/communication C is visible through an opening O in the apparatus A. See also FIGS. 8B, 9B and 10A. According to an exemplary embodiment as indicated in FIG. 4, the insert/communication C may be removed/replaced through the slot L (e.g. without removal of the apparatus from the hose). See also FIGS. 8A and 9A.

According to an exemplary embodiment as indicated in FIGS. 1, 8A/B and 9A/B, a portion of the insert/communication C may protrude from the slot L after the insert/communication has been inserted (and seated/secured) within the frame of the apparatus; the portion P (protruding from the frame R of apparatus A) may be an extension of the sheet C (see FIGS. 8A/B) on an object (see FIGS. 9A/9B). According to an exemplary embodiment, the portion of the insert/communication C that protrudes from the slot L may be in the same (e.g. planar) form as the portion of the insert/communication C within the frame R (see FIGS. 1, 8A/B) or may be in a different form/shape such as the form/shape of a three-dimensional object J (see FIGS. 1, 9A/B); regardless of form the portion P may project from the slot L in a vertical direction (see FIGS. 8A/B) or a horizontal direction (see FIGS. 9A/B) or other direction/orientation.

According to an exemplary embodiment, the insert/communication may present any of a wide variety of content or information including text, image, combination of text/image (e.g. as may be used in marketing/promotion/advertising or other communications/messaging/alerts/etc.). According to an exemplary embodiment the insert/communication may be updated on a routine/regular basis; the insert/communication may comprise a time-sensitive message or a public service announcement or multiple messages/types of messages on multiple topics (see e.g. FIG. 1).

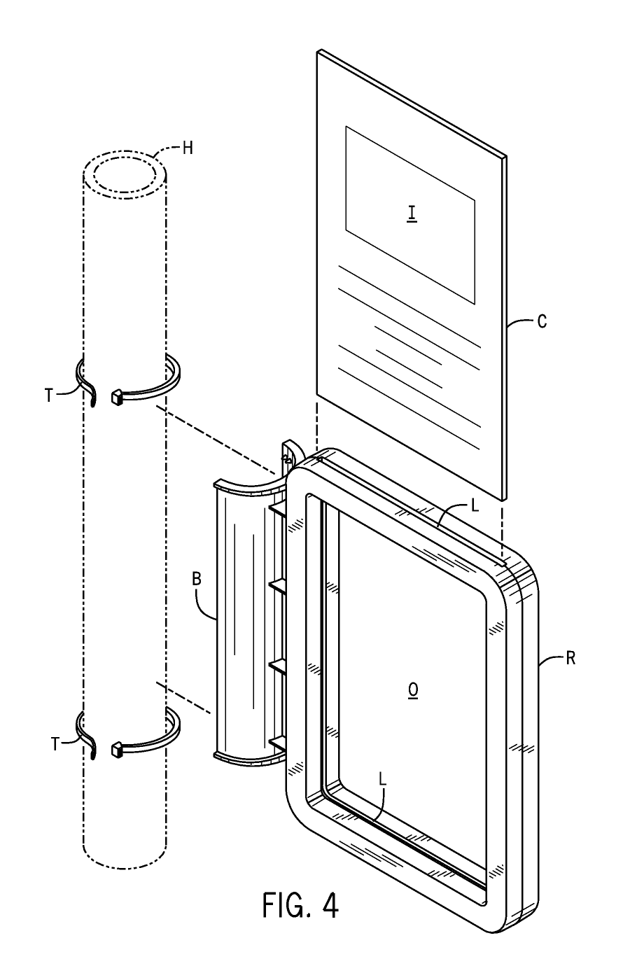

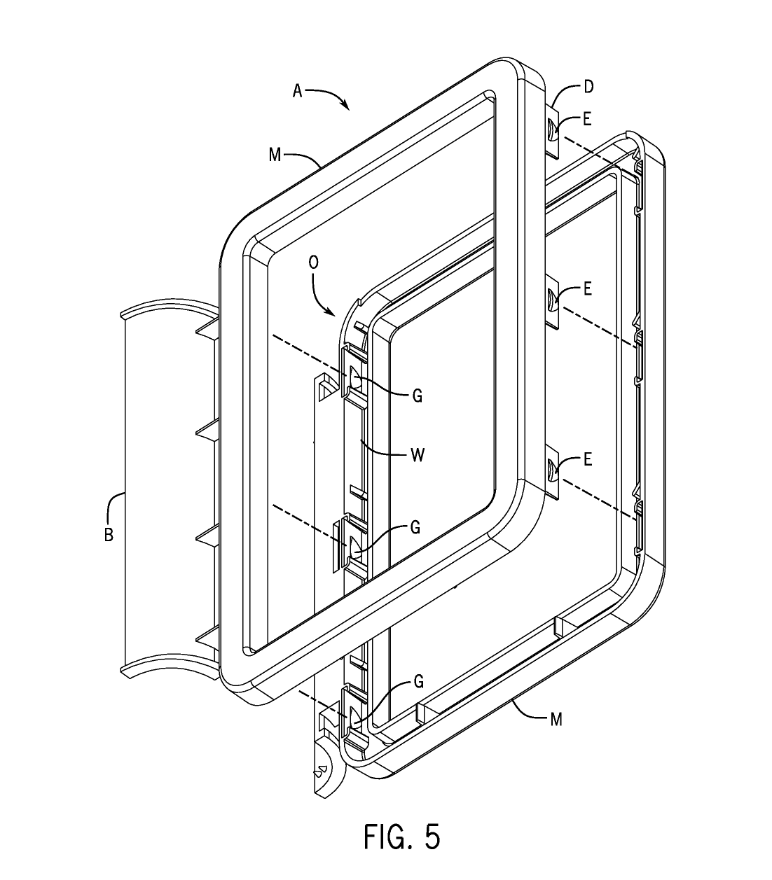

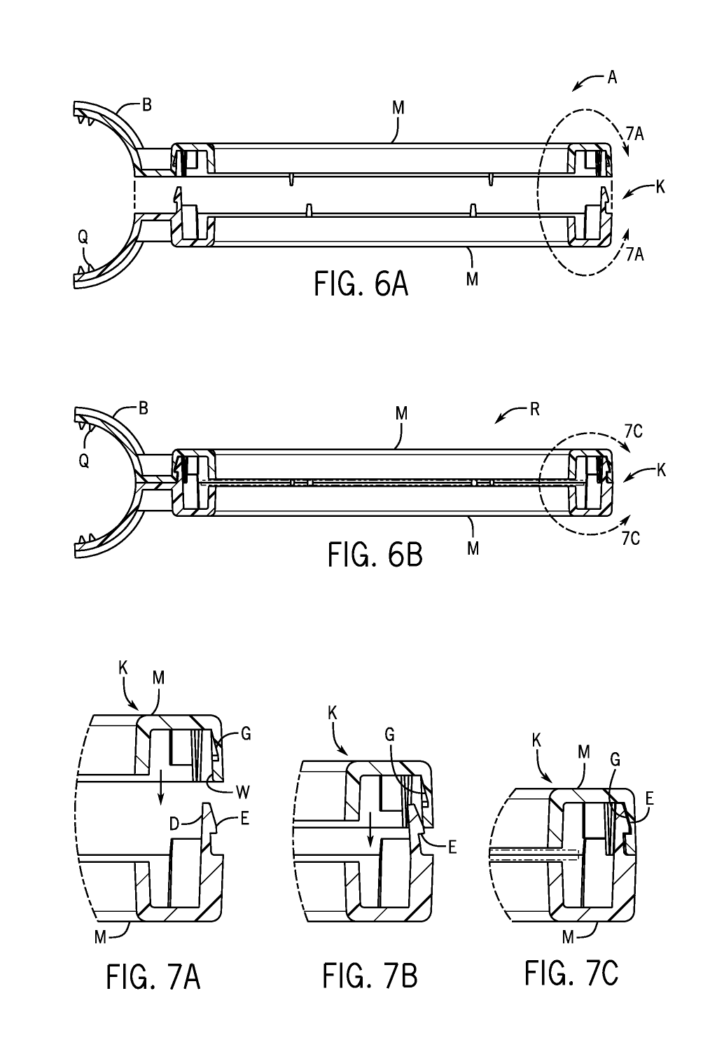

Referring to FIGS. 5 and 6A/B, the assembly of the apparatus A is shown according to an exemplary embodiment. The apparatus A comprises a frame R (e.g. configured to contain the insert) and a base B (e.g. configured to attach to the pump/hose). According to an exemplary embodiment as shown in FIGS. 5 and 6A/B, the frame R of the apparatus A comprises two separate frame sections M; each frame section M combines to form the frame R of the apparatus A; each frame section M is formed with a corresponding base section V; base sections V combine to form the base B of the apparatus. According to an exemplary embodiment, frame sections M are coupled together with a set of clasp mechanisms K (see FIGS. 6A/B and 7A/7C); each clasp mechanism K comprises a clasp structure in the form of a flexible projection D with a barb E (on one frame section) and a retaining structure in the form of a wall segment W with a recess G (e.g. into which the barb E of the projection D is seated) (on the other frame section). See for example FIGS. 6A/B and 7A/7C (showing clasp mechanism components integrally formed with frame sections). According to an exemplary embodiment as shown in FIGS. 2, 5, 6A/B, 8A/B 9A/B 10A/B, attachment of the frame sections M secure the base sections V to form the apparatus A for installation of the insert and attachment to a pump/hose H at the station. (Other details of construction form of the apparatus according to an exemplary embodiment, are indicated in FIGS. 5, 6A/B and 7A/C.)

According to an exemplary embodiment as indicated, the apparatus can be formed and manufactured as a molded plastic assembly of two sections (see FIGS. 5 and 6A) that is securely assembled (e.g. latched or “snapped”) together by fitting engagement and operation of the clasp mechanisms K (e.g. as shown in FIGS. 6B and 7A/C); the sections can be disassembled by separation upon disengagement of the clasp/latch mechanisms (e.g. “unsnapped” or pried apart). (As indicated in FIGS. 2, 8A/B and 9A/B, according to an exemplary embodiment, it is not necessary to disassemble or separate the frame sections to update the insert.)

As indicated schematically and representationally in FIG. 10B, according to an exemplary embodiment base B may be provided with a set of projections shown as teeth Q to facilitate engagement in the surface of the hose H (not shown in FIG. 10B).

As indicated in FIGS. 1 and 10A/B, the frame may be provided in any of a variety of forms/shapes (e.g. with corresponding forms/shapes of insert/communication or of a form/shape configured for the opening of the frame). According to an exemplary embodiment, the frame is provided with a slot for insertion and removal/replacement of the insert/communication; the slot may be provided on the top (or bottom) of the frame or on a side of the frame. Compare FIGS. 8A/B and 9A/B. According to an exemplary embodiment, the apparatus is assembled and shipped without an insert/communication installed (e.g. so that the initial insert is installed at the time of initial use and installation). According to an exemplary embodiment, the insert is seated in the frame when installed through the slot. According to an alternative embodiment, the insert/communication may be installed (e.g. initially) at the same time when the sections of the frame as assembled together.

The insert structure may comprise a flexible sheet, paper, card, rigid sheet, plastic sheet, etc.

According to an exemplary embodiment the information may be provided on at least one structure at the frame; for example, on structure (e.g. shaft) may be inserted in front or behind another structure (e.g. already in the frame) to at least temporarily change the information content at the apparatus.

A method of configuring an apparatus for displaying information *comprising a base and a frame provided on at least one structure at a fueling system providing a hose configured to refuel a vehicle. The apparatus comprises providing the apparatus with the base attachable to the hose, providing the structure with information at the frame coupled to the base and displaying information on the structure at the frame by attachment of the apparatus to the hose. When the apparatus is attached to the hose at the base *information on at least one structure at the frame is visible at the fueling system. The apparatus is configured so that information can be changed at the apparatus without removal of the base from the hose. The apparatus comprises the step of changing the information by removal of the structure and replacing the structure with a replacement structure comprising information without removal of the apparatus or disassembly of the apparatus. The apparatus is configured so that information can be changed by at least one of providing a structure at the frame or removing a first structure from the frame and inserting a second structure in the frame.

It is important to note that the construction and arrangement of the elements of the inventive concepts and inventions as described in this application and as shown in the figures above is illustrative only. Although some embodiments of the present inventions have been described in detail in this disclosure, those skilled in the art who review this disclosure will readily appreciate that many modifications are possible without materially departing from the novel teachings and advantages of the subject matter recited. Accordingly, all such modifications are intended to be included within the scope of the present inventions. Other substitutions, modifications, changes and omissions may be made in the design, operating conditions and arrangement of the preferred and other exemplary embodiments without departing from the spirit of the present inventions.

It is important to note that the apparatus of the present inventions can comprise conventional technology (e.g. as implemented in present configuration) or any other applicable technology (present or future) that has the capability to perform the functions and processes/operations indicated in the FIGURES. All such technology is considered to be within the scope of the present inventions and application.

1. An apparatus for displaying information at a fueling system providing a hose to refuel a vehicle comprising:
(a) a base configured for attachment to the hose;
(b) a frame comprising a first frame section and a second frame section;
(c) a mechanism to secure the first frame section to the second frame section to form the frame;
wherein the frame is configured to display information on a structure;
wherein when the base is attached to the hose the frame with structure comprising information is visible at the fueling system.

2. The apparatus of claim 1 wherein the base is configured attached to the hose with at least one fastener.

3. The apparatus of claim 2 wherein the fastener comprises a zip tie.

4. The apparatus of claim 1 wherein the first frame section and the second frame section are attached by a set of projections fit into a set of recesses.

5. The apparatus of claim 4 wherein the projections comprise barbs configured to fit into recesses.

6. The apparatus of claim 1 wherein the first frame section comprises the base.

7. The apparatus of claim 1 further comprising an opening in the frame configured so that information on the structure is visible through the opening in the frame; wherein the frame provides a slot configured for insertion of the structure; wherein the structure containing information is at least partially inserted into the slot.

8. The apparatus of claim 7 wherein the structure comprises a sheet; wherein the sheet comprises information visible through the opening.

9. The apparatus of claim 7 wherein the structure comprises an object extended out of the slot.

10. An apparatus for displaying information at a repowering system providing a tube by which to repower a vehicle comprising:
(a) a base configured for attachment to the tube;
(b) a first frame section providing the base;
(c) a second frame section attachable to the first frame member;
(d) a frame comprising the first frame section and second frame section configured to display information on a structure;
wherein when the base is attached to the base information on the structure at the frame is positioned to be visible at the system.

11. The apparatus of claim 10 wherein the first frame section and the second frame section are attached by a set of projections fit into a set of recesses.

12. The apparatus of claim 11 wherein the projections comprise barbs configured to fit into recesses.

13. The apparatus of claim 10 wherein the frame is configured for containing the removable structure.

14. The apparatus of claim 13 wherein the structure comprises at least one of a sheet, a flexible sheet, an object.

15. The apparatus of claim 14 further comprising a slot in the frame configured for the structure to be inserted in the slot of the frame.

16. The apparatus of claim 15 wherein structure comprises an object extends from the structure exterior to the slot of the frame.

17. The apparatus of claim 10 wherein the tube is a fuel hose.

18. A method of configuring an apparatus for displaying information *comprising a base and a frame provided on at least one structure at a fueling system providing a hose configured to refuel a vehicle comprising:
(a) providing the apparatus with the base attachable to the hose;
(b) providing the structure with information at the frame coupled to the base;
(c) displaying information on the structure at the frame by attachment of the apparatus to the hose;
wherein when the apparatus is attached to the hose at the base then information on at least one structure at the frame is configured to be visible at the fueling system;
wherein the apparatus is configured so that information can be changed at the apparatus by changing of the structure with information.

19. The method of claim 18 further comprising the step of changing the information by removal of the structure from the apparatus and replacing the structure with a replacement structure comprising information without removal of the apparatus from the hose.

20. The method of claim 19 wherein the step of changing the information is performed by removal and replacement of the structure containing information without disassembly of the apparatus.
